(19) United States
(12) Patent Application Publication
(10) Pub. No.: US 2006/0037363 A1
(43) Pub. Date: Feb. 23, 2006

(54) Heat transfer plate for molding glass

(75) Inventor: Kun-Chih Wang, Taichung (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Asia Optical Co., Inc.

(21) Appl. No.: 11/001,732

(22) Filed: Dec. 1, 2004

(30) Foreign Application Priority Data
Aug. 17, 2004 (TW) 93124630

(51) Int. Cl. C03B 11/08

(52) U.S. Cl. 65/374.11; 65/374.12

(57) ABSTRACT

A heat transfer plate for molding glass. The heat transfer plate includes a substrate having an operating surface, an intermediate layer overlying the operating surface of the substrate, and a passivation film overlying the intermediate layer.

### BACKGROUND

The invention relates to an apparatus for molding glass, and more specifically to a thermally stable heat transfer palate for molding glass.

In a conventional process for molding glass, as shown in FIG. 1, a molding die assembly 100 is disposed on a flat pedestal comprising a base 105, cooling unit 102a, heating unit 103a, and heat transfer plate 200 of a molding apparatus. A flat press comprising a dynamic pressure unit 101, cooling unit 102a, heating unit 103a, and heat transfer plate 200 of the molding apparatus then moves downward and attaches to the molding die assembly 100 in order to heat and pressurize the molding die assembly 100. Thereafter, the press moves upward, drags the molding die assembly 100 on the heat transfer plate 200, thereby transferring the molding die assembly 100 to a next station comprising approximately the same mechanism as the described for heating and pressurizing.

As described, the heat transfer plate 200 is the only component intermediately contacting the molding die assembly 200. Conventionally, the heat transfer plate 200 comprises sintered tungsten carbide superhard alloys. As shown in FIG. 2, the heat transfer plate 200 comprises embedded screw holes in the corners for fixing the heat transfer plate 200 with the heating unit 103a or 103b.

In the molding apparatus, the heat transfer plate 200 acts as a tool for transferring heat and pressure exerting or receiving. The heat transfer plate 200 is therefore under high temperature and high pressure for a predetermined period during a glass molding process. As shown in FIG. 3, oxidation derivatives 202, circular dents 203, dragging marks 204 may form on a surface of the heat transfer plate 200, resulting in a roughened surface thereof. The oxidation derivatives 202 are formed by high temperature oxidation. The dents 203 are formed by contact of the heat transfer plate 200 and molding die assembly 100 at high temperature and under high pressure. The drag marks 204 are formed by dragging of the molding die assembly 100 on the heat transfer plate 200 and high temperature oxidation. Surface roughening of the heat plate 200 may cause the molding die assembly 100 to vibrate thereon, resulting in deviation from product requirements, thereby negatively affecting to production yield. Typically, process deviation appears in 500 molding cycles at 500 to 700° C.

### SUMMARY

Thus, embodiments of the invention provide a heat transfer plate with improved thermal stability and extended life stabilizing the glass molding process, improving product yield and reducing product cost.

Embodiments of the invention provide a heat transfer plate comprising a substrate comprising an operating surface, an intermediate layer overlying the operating surface of the substrate, and a passivation film overlying the intermediate layer.

Embodiments of the invention further provide a heat transfer plate comprising a substrate comprising an operating surface, a first intermediate layer overlying the operating surface of the substrate, a second intermediate layer overlying the first intermediate layer and a passivation film overlying the second intermediate layer.

### BRIEF DESCRIPTION OF THE DRAWINGS

The invention can be more fully understood by reading the subsequent detailed description in conjunction with the examples and references made to the accompanying drawings, wherein:

FIG. 1 is a skeleton diagram of a conventional molding apparatus.

FIG. 2 is a three-dimensional diagram of a conventional heat transfer plate for molding glass.

FIG. 3 a three-dimensional diagram of a conventional heat transfer plate for molding glass with surface oxidation and surface damage resulting from operation at high temperature under high pressure.

FIG. 4 is a cross-section of a heat transfer plate of a first embodiment of the invention.

FIG. 5 is a cross-section of a heat transfer plate of a second embodiment of the invention.

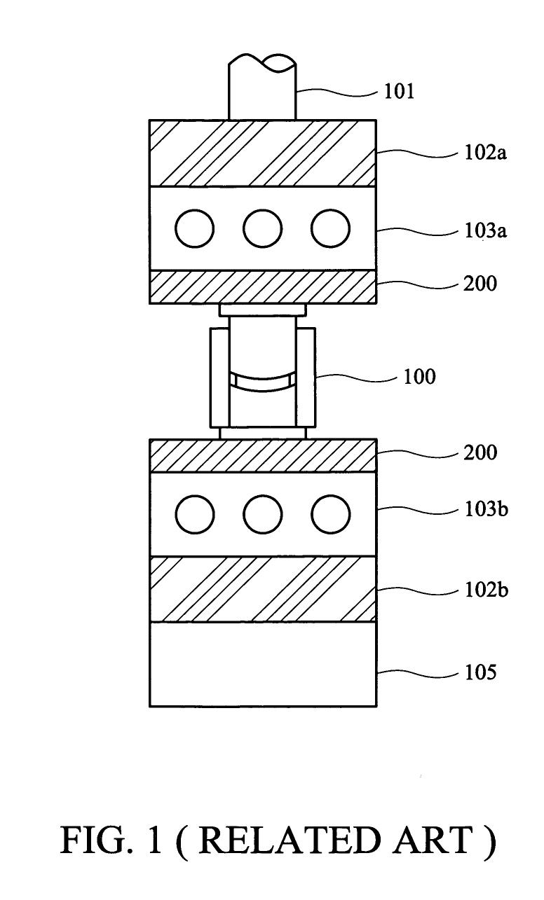

### DETAILED DESCRIPTION

The following embodiments are intended to illustrate the invention more fully without limiting the scope of the claims, since numerous modifications and variations will be apparent to those skilled in this art.

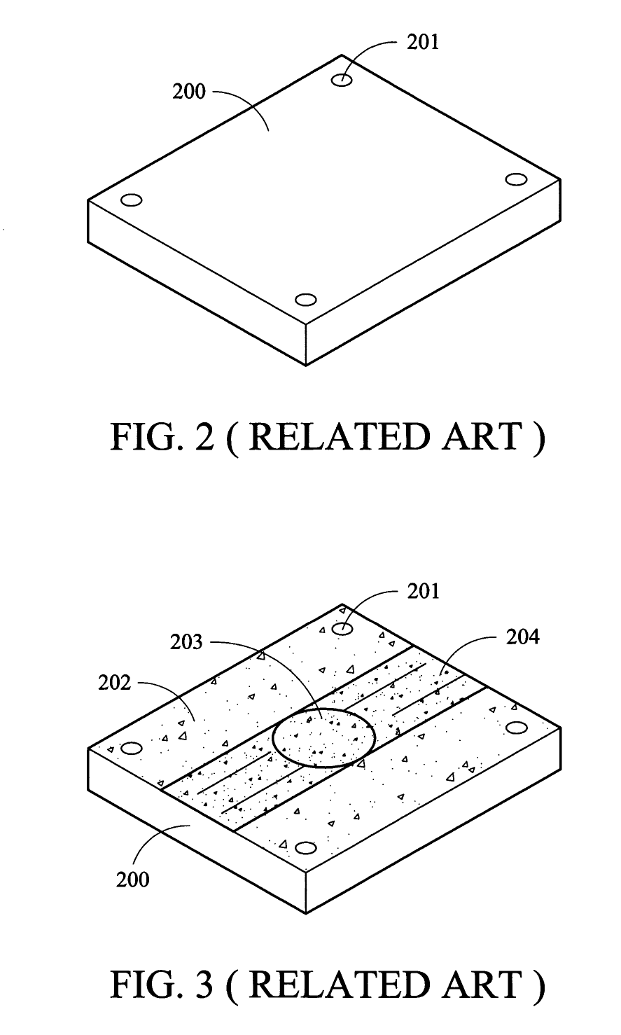

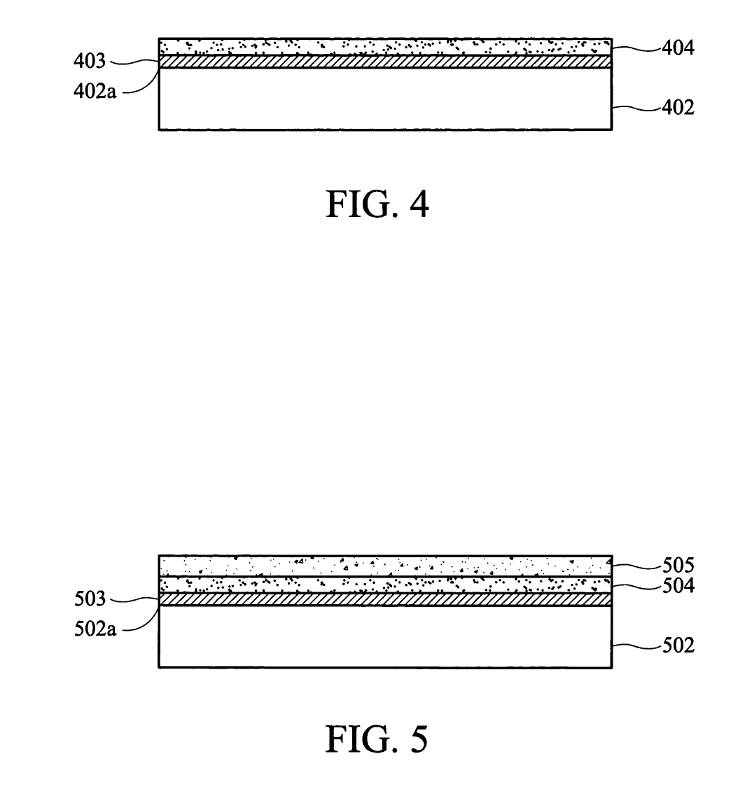

FIG. 4 is a cross-section of a heat transfer plate of a first embodiment of the invention, comprising a substrate 402, intermediate layer 403, and passivation film 404. The heat transfer plate may have embedded screw holes substantially equivalent to those in FIG. 2.

The substrate 402 comprises tungsten carbide, preferably superhard sintered tungsten carbide alloys with thermal expansion coefficient between 4×10⁻⁶/K to 9×10⁻⁶/K. An operating surface 402a of the substrate 402 may be ground and polished, reducing average roughness (Ra) thereof to approximately 5 nm or less, followed by formation of the intermediate layer 403 overlying the operating surface 402a of the substrate 402 using a method such as vacuum sputtering. The intermediate layer 403 preferably comprises Si, Ti, Al, W, Ta, Cr, Zr, V, Nb, Hf, B, or combinations thereof to improve adhesion between the substrate 402 and intermediate layer 403.

Further, the passivation film 404 preferably has chemical inactivity, low friction coefficient, and high hardness to prevent formation of oxidation derivatives, dents, drag marks, and other surface damage to improve process stability and product yield of molding glass, and lifetime thereof at a predetermined molding temperature. Thus, the passivation film 404 preferably comprises nitrides or carbides such as Si, Ti, Al, W, Ta, Cr, Zr, V, Nb, Hf, B, or combinations thereof, and more preferably the nitrides or carbides of the intermediate layer 403 to improve the adhesion therebetween. As described, adhesion among the substrate 402, intermediate layer 403, and passivation film 404 are improved.

When the intermediate layer 403 comprises Si, Ti, Al, W, Ta, Cr, Zr, V, Nb, Hf, B, or combinations thereof, the intermediate layer 403 can be formed by a method such as vacuum sputtering. The substrate 402 is disposed in a chamber (not shown), followed by introduction of an inert gas such as Argon, and at least a Si, Ti, Al, W, Ta, Cr, Zr, V, Nb, Hf, and B target is provided and bias power is applied to each desired target respectively according to the predetermined composition of the intermediate layer 403. Sputtering duration is determined according to the predetermined thickness of the intermediate layer 403 the operating surface 402a of the substrate 402. The intermediate layer 403 is preferably 50 to 250 nm thick.

When the passivation film 404 comprises nitrides or carbides such as Si, Ti, Al, W, Ta, Cr, Zr, V, Nb, Hf, B, or combinations thereof, the passivation film 404 can be formed by a method such as vacuum sputtering. The passivation film 404 is preferably formed immediately after the formation of the intermediate layer 403. When the formation of intermediate layer 403 is complete, the bias power to at least a Si, Ti, Al, W, Ta, Cr, Zr, V, Nb, Hf, and B target is the same as the formation of the intermediate layer 403 and nitrogen or C₂H₂ gas is further introduced into the chamber to form the passivation film 404. The thickness of passivation film 404 is preferably about 500 to 3000 nm. Thus, the heat transfer plate of the invention is complete.

FIG. 5 is a cross-section of a heat transfer plate of a second embodiment of the invention, comprising a substrate 502, first intermediate layer 503, second intermediate layer 504, and passivation film 505. The heat transfer plate may have embedded screw holes substantially equivalent to those in FIG. 2.

The substrate 502 comprises tungsten carbide, preferably superhard sintered tungsten carbide alloys with thermal expansion coefficient between 4×10⁻⁶/K to 9×10⁻⁶/K. An operating surface 502a of the substrate 502 may be ground and polished, reducing average roughness (Ra) thereof to approximately 5 nm or less, followed by formation of the first intermediate layer 503 overlying the operating surface 502a of the substrate 502 using a method such as vacuum sputtering. The first intermediate layer 503 preferably comprises Si, Ti, Al, W, Ta, Cr, Zr, V, Nb, Hf, B, or combinations thereof to improve adhesion between the substrate 502 and first intermediate layer 503.

Further, the passivation film 505 preferably has chemical inactivity, low friction coefficient, and high hardness to prevent formation of oxidation derivatives, dents, drag marks, and other surface damage to improve process stability and product yield of molding glass, and lifetime thereof at a predetermined molding temperature. Thus, the passivation film 505 preferably comprises carbonitrides such as Si, Ti, Al, W, Ta, Cr, Zr, V, Nb, Hf, B, or combinations thereof, and more preferably the carbonitrides of the first intermediate layer 503.

The second intermediate layer 504 preferably comprises nitrides or carbides, such as those of Si, Ti, Al, W, Ta, Cr, Zr, V, Nb, Hf, B, or combinations thereof, and more preferably the nitrides or carbides of the first intermediate layer 503 acting as a transitional layer between the first intermediate layer 503 and passivation film 505 to improve the adhesion therebetween.

As described, adhesion among the substrate 502, first intermediate layer 503, second intermediate layer 504, and passivation film 505 are improved, improving lifetime of the heat transfer plate of the invention and reducing product cost.

When the first intermediate layer 503 comprises Si, Ti, Al, W, Ta, Cr, Zr, V, Nb, Hf, B, or combinations thereof, the first intermediate layer 503 can be formed by a method such as vacuum sputtering. The substrate 502 is disposed in a chamber (not shown), followed by introduction of an inert gas such as Argon, and at least a Si, Ti, Al, W, Ta, Cr, Zr, V, Nb, Hf, and B target is provided and bias power applied to each desired target respectively according to the predetermined composition of the first intermediate layer 503. Sputtering duration is determined according to the predetermined thickness of the first intermediate layer 503 the operating surface 502a of the substrate 502. The intermediate layer 503 is preferably 50 to 250 nm thick.

When the second intermediate layer 504 comprises nitrides or carbides of Si, Ti, Al, W, Ta, Cr, Zr, V, Nb, Hf, B, or combinations thereof, the second intermediate layer 504 can be formed by a method such as vacuum sputtering. The second intermediate layer 504 is preferably formed immediately after formation of the first intermediate layer 503. When formation of the first intermediate layer 503 is complete, the bias power to at least a Si, Ti, Al, W, Ta, Cr, Zr, V, Nb, Hf, and B target is the same as that used during formation of the first intermediate layer 503 and nitrogen or C₂H₂ gas is further introduced into the chamber to form the second intermediate layer 504. The thickness of second intermediate layer 504 is preferably about 100 to 350 nm.

When the passivation film 505 comprises carbonitrides of Si, Ti, Al, W, Ta, Cr, Zr, V, Nb, Hf, B, or combinations thereof, the passivation film 505 can be formed by a method such as vacuum sputtering. The passivation film 505 is preferably formed immediately after formation of the second intermediate layer 504. When formation of the second intermediate layer 504 is complete, the bias power to at least a Si, Ti, Al, W, Ta, Cr, Zr, V, Nb, Hf, and B target is the same as that used during formation of the the second intermediate layer 504 and an argon, nitrogen, and C₂H₂ gases are introduced into the chamber to form the passivation film 505. The thickness of passivation film 404 is preferably about 500 to 3000 nm. Thus, the heat transfer plate of embodiments of the invention is complete.

Examples of the heat transfer plate of embodiments of the invention are provided. Note that the process parameters provided subsequently, such as desired composition, thickness, and thermal stability are only examples, and are not intended to limit the scope of the invention. Those skilled in the art will recognize the possibility of using many possible process parameters, to obtain the molding die of embodiments of the invention and renewal thereof.

### EXAMPLE 1

An operating surface 402a of a superhard alloy of sintered tungsten carbide substrate 402 was ground and polished to reduce average roughness (Ra) to approximately 5 nm or less.

An intermediate layer 403 comprising Ti—Al alloys was formed overlying the operating surface 402a of the substrate 402. The polished substrate 402 was cleaned, and then placed in a chamber (not shown). The intermediate layer 403 was subsequently formed using vacuum sputtering, at about 250 to 450° C., approximately 2×10⁻¹ Pa resulting from introduction of argon streams. Initial RF power was approximately 500 W with a bias of approximately 120V to a Ti—Al target with Ti and Al of approximately 50 atom % respectively to complete formation of the intermediate layer 402 approximately 80 nm thick.

Finally, a passivation film 404 comprising nitrides of Ti and Al was formed overlying the intermediate layer 403 in the same chamber using vacuum sputtering, at about 250 to 450° C., approximately 3×10⁻¹ Pa resulting from sequential introductions of argon streams of approximately 2×10⁻¹ Pa and nitrogen streams of approximately 1×10⁻¹ Pa, and initial RF power of approximately 500 W and bias of approximately 120V to a Ti—Al target with Ti and Al of approximately 50 atom % respectively to complete formation of the passivation film 404 of approximately 1000 nm thick.

Thus, a heat transfer plate, comprising a TiAlN passivation layer, of the invention had low residual stress, high adhesion, and high thermal stability was completed with an oxidation temperature of 800° C. or higher. Thermal stability of embodiments of the heat plate of the invention was approximately twice the conventional, and lifetime thereof was 50000 cycles or more.

### EXAMPLE 2

An operating surface 402a of a superhard alloy of sintered tungsten carbide substrate 502 was ground and polished to reduce average roughness (Ra) to approximately 5 nm or less.

A first intermediate layer 503 comprising Ti—Al alloys was formed overlying the operating surface 502a of the substrate 502. The polished substrate 502 was cleaned, and then placed in a chamber (not shown). The first intermediate layer 503 was subsequently formed using vacuum sputtering, at about 250 to 450° C., approximately 2×10⁻¹ Pa resulting from introduction of argon streams. Initial RF power was approximately 500 W with a bias of approximately 120V to a Ti—Al target with Ti and Al of approximately 50 atom % respectively to complete formation of the first intermediate layer 503 approximately 80 nm thick.

A second intermediate layer 504 comprising nitrides of Ti and Al was then formed overlying the first intermediate layer 503 in the same chamber using vacuum sputtering, at about 250 to 450° C., approximately 3×10⁻¹ Pa resulting from sequential introductions of argon streams of approximately 2×10⁻¹ Pa and nitrogen streams of approximately 1×10⁻¹ Pa, and initial RF power of approximately 500 W and bias of approximately 120V to a Ti—Al target with Ti and Al of approximately 50 atom % respectively to complete formation of the second intermediate layer 504 of approximately 100 nm thick.

Finally, a passivation film 505 comprising carbonitrides of Ti and Al was formed overlying the second intermediate layer 504 in the same chamber using vacuum sputtering, at about 250 to 450° C., approximately 3.5×10⁻¹ Pa resulting from sequential introductions of argon streams of approximately 3×10⁻¹ Pa, nitrogen streams of approximately 1×10⁻¹ Pa, and C₂H₂ streams of approximately 0.5×10⁻¹ Pa, and initial RF power of approximately 500 W and bias of approximately 120V to a Ti—Al target with Ti and Al of approximately 50 atom % respectively to complete formation of the passivation film 505 of approximately 1000 nm thick.

Thus, a heat transfer plate, comprising a TiAlCN passivation layer, of the invention had low residual stress, high adhesion, friction coefficient less than 0.2, and high thermal stability was completed, with an oxidation temperature was 800° C. or higher. Thermal stability of the heat plate of the invention was approximately twice that of the conventional, and lifetime thereof was 50000 cycles or more.

While the invention has been described by way of example and in terms of preferred embodiment, it is to be understood that the invention is not limited thereto. It is therefore intended that the following claims be interpreted as covering all such alteration and modifications as fall within the true spirit and scope of the invention.

What is claimed is:

1. A heat transfer plate for molding glass, comprising:
a substrate comprising an operating surface;
an intermediate layer overlying the operating surface of the substrate; and
a passivation film overlying the intermediate layer.

2. The heat transfer plate as claimed in claim 1, wherein the substrate comprises tungsten carbide.

3. The heat transfer plate as claimed in claim 1, wherein Ra (average roughness) of the operating surface is approximately 5 nm or less.

4. The heat transfer plate as claimed in claim 1, wherein the intermediate layer comprises Si, Ti, Al, W, Ta, Cr, Zr, V, Nb, Hf, B, or combinations thereof.

5. The heat transfer plate as claimed in claim 1, wherein the intermediate layer is about 50 to 250 nm thick.

6. The heat transfer plate as claimed in claim 1, wherein the passivation film comprises nitrides or carbides of the intermediate layer.

7. The heat transfer plate as claimed in claim 1, wherein the passivation film comprises nitrides or carbides of Si, Ti, Al, W, Ta, Cr, Zr, V, Nb, Hf, B, or combinations thereof.

8. The heat transfer plate as claimed in claim 1, wherein the passivation film is about 0.50 to 3.0 μm thick.

9. The heat transfer plate as claimed in claim 1, wherein oxidation temperature of the passivation film is over about 600° C.

10. A heat transfer plate for molding glass, comprising:
a substrate comprising an operating surface;
a first intermediate layer overlying the operating surface of the substrate;
a second intermediate layer overlying the first intermediate layer; and
a passivation film overlying the second intermediate layer.

11. The heat transfer plate as claimed in claim 10, wherein the substrate comprises tungsten carbide.

12. The heat transfer plate as claimed in claim 10, wherein Ra (average roughness) of the operating surface is approximately 5 nm or less.

13. The heat transfer plate as claimed in claim 10, wherein the first intermediate layer comprises Si, Ti, Al, W, Ta, Cr, Zr, V, Nb, Hf, B, or combinations thereof.

14. The heat transfer plate as claimed in claim 10, wherein the first intermediate layer is about 50 to 250 nm thick.

15. The heat transfer plate as claimed in claim 10, wherein the second intermediate layer comprises nitrides or carbides of the first intermediate layer.

16. The heat transfer plate as claimed in claim 10, wherein the second intermediate layer comprises nitrides or carbides of Si, Ti, Al, W, Ta, Cr, Zr, V, Nb, Hf, B, or combinations thereof.

17. The heat transfer plate as claimed in claim 10, wherein the second intermediate layer is about 50 to 350 nm thick.

18. The heat transfer plate as claimed in claim 10, wherein the passivation film comprises carbonitrides of the first intermediate layer.

19. The heat transfer plate as claimed in claim 10, wherein the passivation film comprises carbonitrides of Si, Ti, Al, W, Ta, Cr, Zr, V, Nb, Hf, B, or combinations thereof.

20. The heat transfer plate as claimed in claim 10, wherein the passivation film is about 0.50 to 3.0 μm thick.

21. The heat transfer plate as claimed in claim 10, wherein oxidation temperature of the passivation film is over about 600° C.
